(19) United States
(12) Patent Application Publication
(10) Pub. No.: US 2012/0224298 A1
(43) Pub. Date: Sep. 6, 2012

(54) MULTILAYER CERAMIC CAPACITOR

(75) Inventors: Hyun Woo KIM, Suwon (KR); Seon Cheol Park, Suwon (KR); Kang Heon Hur, Seongnam (KR); Doo Young Kim, Yongin (KR)

(73) Assignee: SAMSUNG ELECTRO-MECHANICS CO., LTD.

(21) Appl. No.: 13/166,304

(22) Filed: Jun. 22, 2011

(30) Foreign Application Priority Data
Mar. 2, 2011 (KR) 10-2011-0018541

(51) Int. Cl. H01G 4/12; H01G 4/06

(52) U.S. Cl. 361/321.4; 361/321.2

(57) ABSTRACT

There is provided a multilayer ceramic capacitor including: a ceramic main body having first and second side faces opposed to each other and third and fourth side faces connecting the first and second side faces; a plurality of inner electrodes formed within the ceramic main body and having respective one ends thereof exposed to the third and fourth side faces; external electrodes formed on the third and fourth side faces and electrically connected to the inner electrodes; and dielectric layers alternately stacked with the inner electrodes and made of ceramic powder, wherein a grain size of the ceramic powder is 130 μm or smaller. Acoustic noise generated from the multilayer ceramic capacitor can be reduced by adjusting the grain size of the ceramic powder, a chip permittivity, and the thickness of the dielectric layer, and thus, noise of an electronic product employing the multilayer ceramic capacitor can be reduced.

### CROSS-REFERENCE TO RELATED APPLICATIONS

This application claims the priority of Korean Patent Application No. 10-2011-0018541 filed on Mar. 2, 2011, in the Korean Intellectual Property Office, the disclosure of which is incorporated herein by reference.

### BACKGROUND OF THE INVENTION

1. Field of the Invention

The present invention relates to a multilayer ceramic capacitor and, more particularly, to a multilayer ceramic capacitor capable of reducing acoustic noise generated when voltage is applied to the multilayer ceramic capacitor, and a manufacturing method thereof.

2. Description of the Related Art

In general, a multilayer ceramic capacitor is commonly used as a component of mobile communication devices such as computers, PDAs (personal digital assistants), mobile phones, and the like, due to the advantages of being small, guaranteeing high capacity, and being easily mounted. Recently, as electronic products have been reduced in size and have developed multifunctionality, chip components have also become compact and highly functional, so a multilayer ceramic capacitor which is small but has a high capacity is in demand.

In the related art multilayer ceramic capacitor, a conductive paste is printed onto a ceramic green sheet to form an inner electrode. Tens to hundreds of ceramic green sheets, each with an inner electrode formed thereon, are stacked in an overlapping manner to form a green ceramic laminate. Thereafter, the green ceramic laminate is compressed at high temperature and high pressure to form a hard green ceramic laminate, which is then subjected to a cutting process to manufacture a green chip. The green chip is then plasticized, fired, and thereafter, outer electrodes are formed thereon, thus completing a multilayer ceramic capacitor.

However, in the related art high capacity multilayer ceramic capacitor formed in this manner, ferroelectrics are used to form the ceramic green sheet, which causes a piezo effect when an AC voltage or a DC voltage is applied, making vibrations of the multilayer ceramic capacitor spread to a substrate to generate acoustic noise. Such acoustic noise causes inconvenient noise when an electronic product employing the multilayer ceramic capacitor is in use.

### SUMMARY OF THE INVENTION

An aspect of the present invention provides a multilayer ceramic capacitor capable of significantly reducing acoustic noise.

According to an aspect of the present invention, there is provided a multilayer ceramic capacitor including: a ceramic main body having first and second side faces opposed to each other and third and fourth side faces connecting the first and second side faces; a plurality of inner electrodes formed within the ceramic main body and having respective one ends thereof exposed to the third and fourth side faces; external electrodes formed on the third and fourth side faces and electrically connected to the inner electrodes; and dielectric layers alternately stacked with the inner electrodes and made of ceramic powder, wherein a grain size of the ceramic powder is 130 μm or smaller.

A grain size of the ceramic powder of the dielectric layer may be 50 μm or greater.

The ceramic powder may include BaTiO₃ powder.

The dielectric layer may further include one or more selected from the group consisting of manganese (Mn) oxide, yttrium (Y) oxide, dysprosium (Dy) oxide, magnesium (Mg) oxide, and silicon (Si) oxide.

A chip permittivity calculated by equation shown below ranges from 300 to 3,400,

$${ɛ}_{r} = \frac{{C}_{p} \times T}{{ɛ}_{0} \times A \times ( n - 1 )} \qquad Equation$$

wherein εᵣ is chip permittivity, ε₀ is vacuum permittivity, Cp is multilayer ceramic capacitor capacity, T is a thickness of the dielectric layer, A is an overlap area of the stacked inner electrodes, and n is the number of stacked layers.

The thickness of the dielectric layer, which corresponds to an interval between adjacent inner electrodes in a stacking direction of the inner electrodes, may range from 0.5 μm to 7 μm.

An average value Rg of grain diameters of the dielectric layer may range from 53 μm to 138 μm.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic perspective view of a multilayer ceramic capacitor according to an exemplary embodiment of the present invention;

FIG. 2 is a cross-sectional view taken along line B-B′ of FIG. 1;

FIG. 3A is a cross-sectional view taken along line A-A′ of FIG. 1 for explaining a method of measuring the thickness of a dielectric layer;

FIG. 3B is an image showing an enlarged sectional view of a portion P2 of FIG. 3A taken along line C-C′ of FIG. 1; and

FIG. 4 is an image of a portion of a dielectric layer for explaining a method of measuring an average value of grain diameters.

### DETAILED DESCRIPTION OF THE PREFERRED EMBODIMENT

Exemplary embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions of components may be exaggerated for clarity, and the same reference numerals will be used throughout to designate the same or like components.

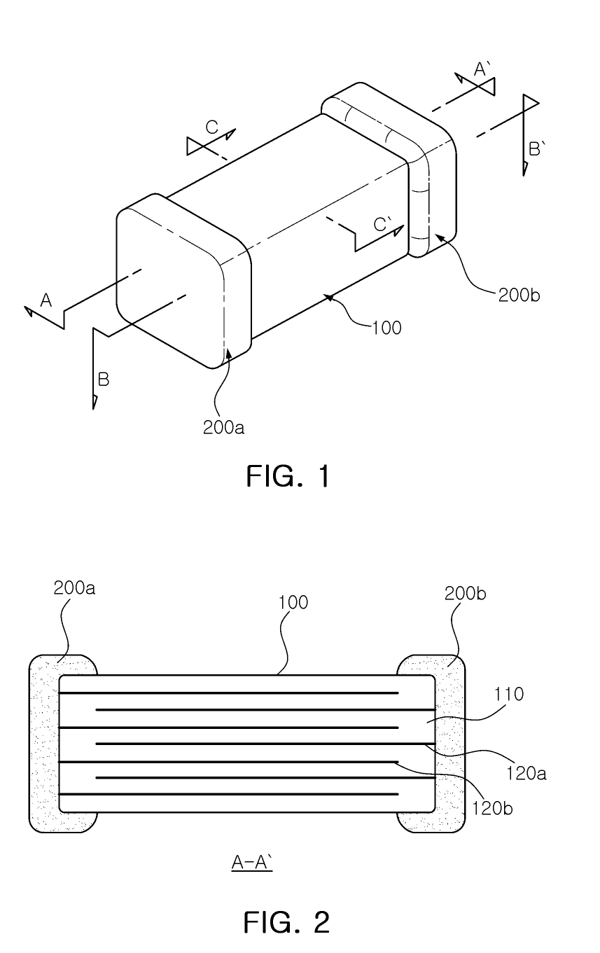

FIG. 1 is a schematic perspective view of a multilayer ceramic capacitor according to an exemplary embodiment of the present invention.

With reference to FIG. 1, a multilayer ceramic capacitor according to an exemplary embodiment of the present invention may include a ceramic main body 100 and outer electrodes 200a and 200b.

The ceramic main body may have first and second side faces opposed to each other and third and fourth side faces connecting the first and second side faces.

In the ceramic main body 100, a plurality of dielectric layers may be stacked, and first and second inner electrodes 120a and 120b may be alternately stacked in an opposing manner with dielectric layers interposed therebetween.

A ceramic powder grain size may range from 50 μm to 130 μm. The ceramic powder may have BaTiO₃ powder as the principal ingredient thereof, and may further include one or more secondary ingredients selected from the group consisting of manganese (Mn) oxide, yttrium (Y) oxide, dysprosium (Dy) oxide, magnesium (Mg) oxide, and silicon (Si) oxide.

When the dielectric layer is formed of the ceramic powder including the BaTiO₃ powder, the grain size thereof becomes different due to cohesion, or the like, of powder after a firing operation. According to an exemplary embodiment of the present invention, an average value Rg of grain diameters may range from 53 μm to 138 μm.

FIG. 2 is a cross-sectional view taken along line B-B′ of FIG. 1.

The inner electrodes 120a and 120b illustrated in FIG. 2 are respectively formed on single dielectric layers in a process of stacking the plurality of dielectric layers. The inner electrodes 120a and 120b are formed with a single dielectric layer interposed therebetween in the interior of the ceramic main body 100 through a sintering operation. The first and second inner electrodes 120a and 120b having different polarities maybe paired and may be disposed to face each other along a direction in which the dielectric layers are stacked. One end of each of the first and second inner electrodes is alternately exposed to both sides of the ceramic main body 100.

The first and second inner electrodes 120a and 120b may be made of conductive metal. For example, the first and second inner electrodes 120a and 120b may be made of nickel (Ni) or a nickel alloy, but the present invention is not limited thereto.

The outer electrodes 200a and 200b may be formed on both sides of the ceramic main body 100. The outer electrodes 200a and 200b may be electrically connected to respective one ends of the first and second inner electrodes 120a and 120b exposed to an outer surface of the ceramic main body 100, thus serving as external terminals. The outer electrodes 200a and 200b may be made of copper (Cu).

A chip permittivity εᵣ of the dielectric layer formed of ceramic powder calculated by the equation shown below may range from 300 to 3,400.

$${ɛ}_{r} = \frac{{C}_{p} \times T}{{ɛ}_{0} \times A \times ( n - 1 )} \qquad Equation$$

Here, εᵣ is chip permittivity, ε₀ is vacuum permittivity, Cp is multilayer ceramic capacitor capacity, T is the thickness of the dielectric layer, A is an overlap area of the stacked inner electrodes 120a and 120b, and n is the number of stacked layers.

Also, the capacity of the multilayer ceramic capacitor is a value measured at a point in time at which two hours have elapsed after thermal treatment has been performed for one hour at 150° C.

The thickness T of the dielectric layer, which corresponds to the interval between the adjacent inner electrodes 120a and 120b in the stacked direction thereof, may range from 0.5 μm to 7 μm.

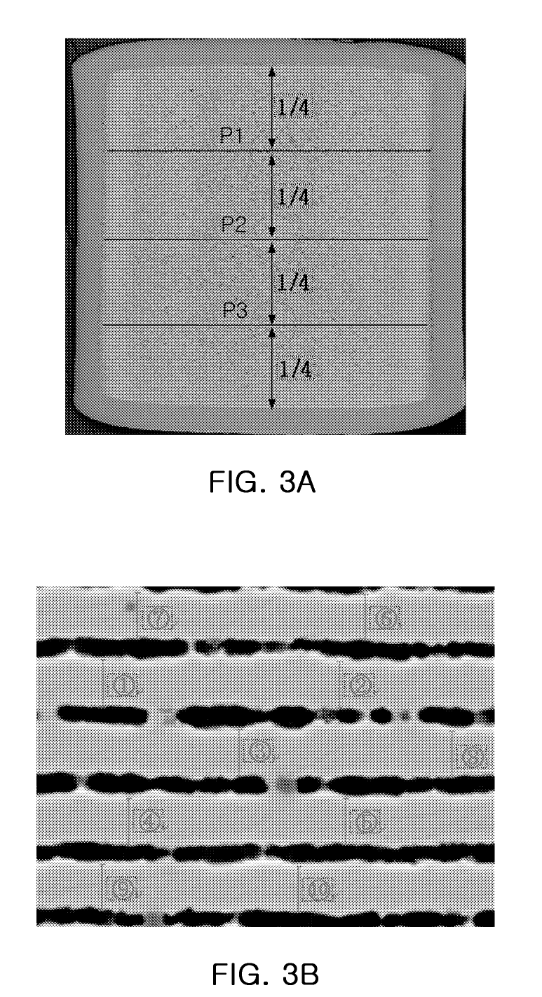

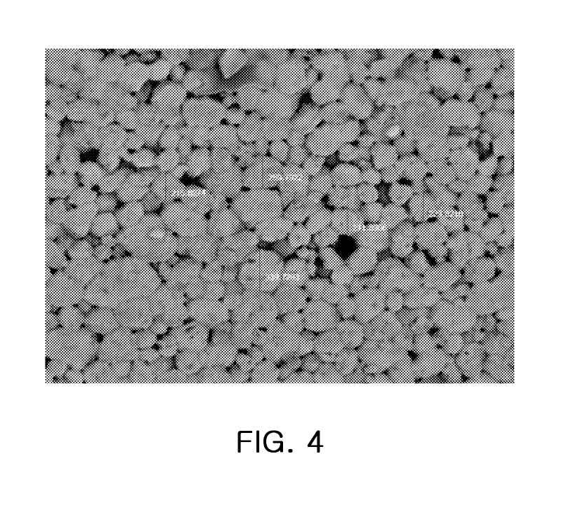

Hereinafter, a method of measuring the thickness T of the dielectric layer and the average value Rg of grain diameters after the multilayer ceramic capacitor is formed will be described with reference to FIGS. 3A, 3B and 4.

FIG. 3A is a cross-sectional view taken along line A-A′ of FIG. 1 for explaining a method of measuring the thickness T of the dielectric layer, and FIG. 3B is an image showing an enlarged sectional view of a portion P2 of FIG. 3A taken along line C-C′ of FIG. 1.

As shown in FIG. 3A, in order to measure the thickness T of the dielectric layer, the overall length of the inner electrodes 120a and 120b is quartered and points P1 to P3 are selected. An image is captured at one of the points P1 to P3 in the direction of the C-C′ section of FIG. 1 by using an optical microscope.

FIG. 3B illustrates an image showing the section at one point among P1 to P3 captured in the foregoing manner. As shown in FIG. 3B, the thicknesses T of the dielectric layers from \textcircled{1} to \textcircled{10} points are measured and an average value thereof is calculated. The respective average values at P1 to P3 are calculated, and then, the calculated average values are averaged to calculate the thickness T of the dielectric layer.

FIG. 4 is an image of a portion of a dielectric layer for explaining a method of measuring an average value Rg of grain diameters.

With reference to FIG. 4, the average value Rg of the grain diameters was measured as follows: A test sample was etched with a solution obtained by diluting hydrochloric acid (HCL) and nitric acid (HNO₃), an image of the test sample was captured by using an scanning electron microscope (SEM) and was then measured by using an image analyzer as shown in FIG. 4. In order to increase the reliability of measurement, 50 measurement points were randomly selected, an average value of the selected points was obtained, and the average value Rg of the grain diameters was calculated.

Meanwhile, Table 1 below shows the results of the evaluation of acoustic noise of a multilayer ceramic capacitor according to the size of BaTiO₃ powder grains, the thickness T of the dielectric layer, the chip permittivity εᵣ, and the average value Rg of grain diameters.

In this case, the multilayer ceramic capacitor was manufactured by stacking printed ceramic green sheets to form a laminate, and then performing pressing, cutting and firing processes, forming the outer electrodes 200a and 200b, plating, and the like.

Thereafter, in order to measure acoustic noise of the manufactured multilayer ceramic capacitor, the multilayer ceramic capacitor was mounted on a test substrate in a non-vibration chamber, noise was then measured 30 times for each Example at DC 1.25V and 100 mA, and an average value was obtained. In case of acoustic noise, a noise case greater than 50 dB was set as a reference for determining the presence of audible noise. In a case in which noise is smaller than 50 dB by 5 dB, the noise level is determined to be excellent since audible noise is greatly reduced. The measurement values were evaluated based on this reference and shown in Table 1 below. A case in which the size of BaTiO₃ powder grains was 50 μm or smaller was excluded because, in that case, it is difficult to distribute or disperse powder in a firing operation and it is also difficult to control the grain size thereof.

TABLE 1

| | | Size of | Thickness of | | | | |
|---|---|---|---|---|---|---|---|
| | Test | BaTiO₃ | dielectric | | Average grain | Acoustic | |
| | sample | powder | layer (after | Chip | diameter | noise | |
| | No. | grain (μm) | firing), (μm) | permittivity | ((μm) | (dB) | Evaluation |
| Comparative | 1 | 300 | 0.5 | 5,500 | 321 | 53 | Normal |
| Example | 2 | 300 | 3 | 5,500 | 321 | 52 | Normal |
| | 3 | 300 | 7 | 5,500 | 321 | 51 | Normal |
| | 4 | 300 | 0.5 | 4,600 | 321 | 53 | Normal |
| | 5 | 300 | 3 | 4,600 | 321 | 52 | Normal |
| | 6 | 300 | 7. | 4,600 | 321 | 51 | Normal |
| | 7 | 300 | 0.5 | 3,500 | 321 | 52 | Normal |
| | 8 | 300 | 3 | 3,500 | 321 | 51 | Normal |
| | 9 | 300 | 7. | 3,500 | 321 | 50 | Normal |
| | 10 | 300 | 0.5 | 2,400 | 321 | 52 | Normal |
| | 11 | 300 | 3 | 2,400 | 321 | 51 | Normal |
| | 12 | 300 | 7. | 2,400 | 321 | 50 | Normal |
| | 13 | 250 | 0.5 | 4,600 | 265 | 50 | Normal |
| | 14 | 250 | 3 | 4,600 | 265 | 49 | Normal |
| | 15 | 250 | 7. | 4,600 | 265 | 48 | Normal |
| | 16 | 250 | 0.5 | 4,000 | 265 | 49 | Normal |
| | 17 | 250 | 3 | 4,000 | 265 | 48 | Normal |
| | 18 | 250 | 7. | 4,000 | 265 | 46 | Normal |
| | 19 | 250 | 0.5 | 4,000 | 265 | 49 | Normal |
| | 20 | 250 | 3 | 4,000 | 265 | 48 | Normal |
| | 21 | 250 | 7. | 4,000 | 265 | 47 | Normal |
| | 22 | 250 | 0.5 | 3,300 | 265 | 48 | Normal |
| | 23 | 250 | 3 | 3,300 | 265 | 47 | Normal |
| | 24 | 250 | 7. | 3,300 | 265 | 46 | Normal |
| | 25 | 250 | 0.5 | 2,700 | 265 | 47 | Normal |
| | 26 | 250 | 3 | 2,700 | 265 | 46 | Normal |
| | 27 | 250 | 7. | 2,700 | 265 | 45 | Excellent |
| | 28 | 180 | 0.5 | 4,000 | 191 | 48 | Normal |
| | 29 | 180 | 3 | 4,000 | 191 | 47 | Normal |
| | 30 | 180 | 7. | 4,000 | 191 | 46 | Normal |
| | 31 | 180 | 0.5 | 3,400 | 191 | 47 | Normal |
| | 32 | 180 | 3 | 3,400 | 191 | 46 | normal |
| | 33 | 180 | 7. | 3,400 | 191 | 45 | Excellent |
| | 34 | 180 | 0.5 | 2,800 | 191 | 46 | Normal |
| | 35 | 180 | 3 | 2,800 | 191 | 45 | Excellent |
| | 36 | 180 | 7. | 2,800 | 191 | 44 | Excellent |
| | 37 | 180 | 0.5 | 2,200 | 191 | 45 | Excellent |
| | 38 | 180 | 3 | 2,200 | 191 | 44 | Excellent |
| | 39 | 180 | 7. | 2,200 | 191 | 43 | Excellent |
| Example | 40 | 130 | 0.5 | 3,400 | 138 | 45 | Excellent |
| | 41 | 130 | 3 | 3,400 | 138 | 44 | Excellent |
| | 42 | 130 | 7. | 3,400 | 138 | 43 | Excellent |
| | 43 | 130 | 0.5 | 2,800 | 138 | 44 | Excellent |
| | 44 | 130 | 3 | 2,800 | 138 | 43 | Excellent |
| | 45 | 130 | 7. | 2,800 | 138 | 42 | Excellent |
| | 46 | 130 | 0.5 | 2,200 | 138 | 43 | Excellent |
| | 47 | 130 | 3 | 2,200 | 138 | 42 | Excellent |
| | 48 | 130 | 7. | 2,200 | 138 | 41 | Excellent |
| | 49 | 130 | 0.5 | 1,600 | 138 | 42 | Excellent |
| | 50 | 130 | 3 | 1,600 | 138 | 41 | Excellent |
| | 51 | 130 | 7. | 1,600 | 138 | 40 | Excellent |
| | 52 | 100 | 0.5 | 2,600 | 106 | 42 | Excellent |
| | 53 | 100 | 3 | 2,600 | 106 | 41 | Excellent |
| | 54 | 100 | 7. | 2,600 | 106 | 40 | Excellent |
| | 55 | 100 | 0.5 | 2,000 | 106 | 41 | Excellent |
| | 56 | 100 | 3 | 2,000 | 106 | 40 | Excellent |
| | 57 | 100 | 7. | 2,000 | 106 | 39 | Excellent |
| | 58 | 100 | 0.5 | 1,400 | 106 | 40 | Excellent |
| | 59 | 100 | 3 | 1,400 | 106 | 39 | Excellent |
| | 60 | 100 | 7. | 1,400 | 106 | 38 | Excellent |
| | 61 | 100 | 0.5 | 800 | 106 | 39 | Excellent |
| | 62 | 100 | 3 | 800 | 106 | 38 | Excellent |
| | 63 | 100 | 7. | 800 | 106 | 37 | Excellent |
| | 64 | 70 | 0.5 | 1,700 | 74 | 39 | Excellent |
| | 65 | 70 | 3 | 1,700 | 74 | 39 | Excellent |
| | 66 | 70 | 7. | 1,700 | 74 | 39 | Excellent |
| | 67 | 70 | 0.5 | 1,300 | 74 | 38 | Excellent |
| | 68 | 70 | 3 | 1,300 | 74 | 38 | Excellent |
| | 69 | 70 | 7. | 1,300 | 74 | 38 | Excellent |
| | 70 | 70 | 0.5 | 900 | 74 | 37 | Excellent |
| | 71 | 70 | 3 | 900 | 74 | 37 | Excellent |
| | 72 | 70 | 7. | 900 | 74 | 37 | Excellent |
| | 73 | 70 | 0.5 | 600 | 74 | 36 | Excellent |
| | 74 | 70 | 3 | 600 | 74 | 36 | Excellent |
| | 75 | 70 | 7. | 600 | 74 | 36 | Excellent |
| | 76 | 50 | 0.5 | 1,100 | 53 | 36 | Excellent |
| | 77 | 50 | 3 | 1,100 | 53 | 36 | Excellent |
| | 78 | 50 | 7. | 1,100 | 53 | 36 | Excellent |
| | 79 | 50 | 0.5 | 800 | 53 | 35 | Excellent |
| | 80 | 50 | 3 | 800 | 53 | 35 | Excellent |
| | 81 | 50 | 7. | 800 | 53 | 35 | Excellent |
| | 82 | 50 | 0.5 | 500 | 53 | 34 | Excellent |
| | 83 | 50 | 3 | 500 | 53 | 34 | Excellent |
| | 84 | 50 | 7. | 500 | 53 | 34 | Excellent |
| | 85 | 50 | 0.5 | 300 | 53 | 33 | Excellent |
| | 86 | 50 | 3 | 300 | 53 | 33 | Excellent |
| | 87 | 50 | 7. | 300 | 53 | 33 | Excellent |

With reference to Table 1, it is noted that, in Comparative Examples 1 to 12, the size of BaTiO₃ powder grains was 300 μm and the average value Rg of grain diameters after a firing operation was 321 μm, while acoustic noise was not improved in spite of a change in the thickness T of the dielectric layer and the chip permittivity εᵣ.

Also, in Comparative Examples 28 to 39, the acoustic noise was evaluated to be excellent only when the chip permittivity εᵣ was 2800 or less.

In Examples 40 to 87, the acoustic noise was 45 dB or less, which was evaluated to be excellent in all of the Examples in which the size of BaTiO₃ powder grains was 130 μm or less, the thickness T of the dielectric layer was 0.5 to 7 μm, and the chip permittivity εᵣ was 3400 or less.

Also, it is noted that the evaluation results of acoustic noise were excellent as the size of BaTiO₃ powder grains was reduced, the thickness T of the dielectric layer was increased, and the chip permittivity εᵣ was reduced in the test results of Table 1.

Namely, it is noted that the acoustic noise was reduced by 5 dB or more when the size of BaTiO₃ powder grains ranged from 50 μm to 130 μm, when the chip permittivity εᵣ ranged from 300 to 3,400, and when the thickness T of the dielectric layer ranged from 0.5 μm to 7 μm.

As set forth above, according to exemplary embodiments of the invention, acoustic noise generated from a multilayer ceramic capacitor can be reduced by adjusting the size of ceramic powder grains, a chip permittivity, and the thickness of a dielectric layer, and thus, noise of an electronic product employing the multilayer ceramic capacitor can be reduced.

While the present invention has been shown and described in connection with the exemplary embodiments, it will be apparent to those skilled in the art that modifications and variations can be made without departing from the spirit and scope of the invention as defined by the appended claims.

What is claimed is:

1. A multilayer ceramic capacitor comprising:
a ceramic main body having first and second side faces opposed to each other and third and fourth side faces connecting the first and second side faces;
a plurality of inner electrodes formed within the ceramic main body and having respective one ends thereof exposed to the third and fourth side faces;
external electrodes formed on the third and fourth side faces and electrically connected to the inner electrodes; and
dielectric layers alternately stacked with the inner electrodes and made of ceramic powder,
wherein a grain size of the ceramic powder is 130 μm or smaller.

2. The multilayer ceramic capacitor of claim 1, wherein the grain size of the ceramic powder of the dielectric layer is 50 μm or greater.

3. The multilayer ceramic capacitor of claim 2, wherein the ceramic powder comprises BaTiO₃ powder.

4. The multilayer ceramic capacitor of claim 3, wherein the dielectric layer further comprises one or more selected from the group consisting of manganese (Mn) oxide, yttrium (Y) oxide, dysprosium (Dy) oxide, magnesium (Mg) oxide, and silicon (Si) oxide.

5. The multilayer ceramic capacitor of claim 2, wherein a chip permittivity calculated by equation shown below ranges from 300 to 3,400,
$${ɛ}_{r} = \frac{{C}_{p} \times T}{{ɛ}_{0} \times A \times ( n - 1 )} \qquad Equation$$
wherein εᵣ is chip permittivity, ε₀ is vacuum permittivity, Cp is multilayer ceramic capacitor capacity, T is a thickness of the dielectric layer, A is an overlap area of the stacked inner electrodes, and n is the number of stacked layers.

6. The multilayer ceramic capacitor of claim 2, wherein the thickness of the dielectric layer, which corresponds to an interval between adjacent inner electrodes in a stacking direction of the inner electrodes, ranges from 0.5 μm to 7 μm.

7. The multilayer ceramic capacitor of claim 5, wherein the thickness of the dielectric layer, which corresponds to an interval between adjacent inner electrodes in a stacking direction of the inner electrodes, ranges from 0.5 μm to 7 μm.

8. The multilayer ceramic capacitor of claim 1, wherein an average value of grain diameters of the dielectric layer ranges from 53 μm to 138 μm.
